(19) United States
(12) Patent Application Publication
(10) Pub. No.: US 2026/0156701 A1
(43) Pub. Date: Jun. 4, 2026

(54) METHODS, APPARATUSES AND COMPUTER PROGRAM FOR ESTABLISHING A MULTI-ACCESS DATA SESSION IN A MOBILE NETWORK

(71) Applicant: Nokia Technologies Oy, Espoo (FI)

(72) Inventors: Mohamed Amin NASSAR, Munich (DE); Rainer LIEBHART, Munich (DE); Georgios GKELLAS, Athens (GR); Bruno LANDAIS, Lannion (FR); Laurent THIÉBAUT, Massy (FR)

(21) Appl. No.: 19/130,450

(22) PCT Filed: Dec. 5, 2023
(86) PCT No.: PCT/IB2023/062263

§ 371 Date: May 15, 2025

(30) Foreign Application Priority Data
Dec. 8, 2022 (GB) 2218433.7

(51) Int. Cl. H04W 76/15; H04W 60/00

(52) U.S. Cl. CPC H04W 76/15; H04W 60/005

(57) ABSTRACT

A method for an apparatus, the method comprising: receiving a policy, the policy comprising policy information indicating preferences on which access paths from a plurality of access paths a multi-access data session for application traffic is to be established, the plurality of access paths being over at least two accesses operating according to a first standard or at least two accesses operating according to a further standard; selecting, for a multi-access data session, at least two access paths from the plurality of access paths based on the policy information; and requesting establishment of the multi-access data session for the application traffic over the selected at least two access paths, the selected at least two access paths being over the at least two accesses operating according to the first standard or at least two accesses operating according to the further standard

### RELATED APPLICATIONS

This patent application claims the benefit of priority of United Kingdom Patent Application No. 2218433.7 filed Dec. 8, 2022, which is hereby incorporated by reference as if reproduced in its entirety.

### FIELD

Embodiments of the present application relate to a method, apparatus, system and computer program for establishing a multi-access data session in a mobile network.

### BACKGROUND

A communication system can be seen as a facility that enables communications between two or more entities, such as terminals or other nodes or terminals and other nodes or provides connected services to entities. Communications may carry, for example, voice, video, electronic mail (email), text message, multimedia data or content data and so on. Non-limiting examples of connected services provided by the communications system may comprise enhanced mobile broadband, ultra-reliable low latency communications, mission-critical communications, massive internet of things (IoT), and multimedia services.

A mobile network can include one or more communication systems and one or more compatible terminals (otherwise known as communication devices). Examples of mobile networks include a public land mobile network or a standalone non-public network. In a communication system at least a part of communications between at least two entities occurs over a wireless link. Communication systems generally include access networks and a core network. An access network may be a radio access network, such as a terrestrial radio access network or non-terrestrial radio access network (e.g., satellite network), a wireless local network, such as a wireless local area network (WLAN), or a fixed network. Mobile networks can include cells and are therefore often referred to as cellular networks.

A terminal may be referred to as user equipment (UE) or user device. A terminal is provided with an appropriate signal receiving and transmitting apparatus for enabling wireless communications, for example enabling access to a mobile network or communications directly with other terminals. The terminal may access a carrier provided by a base station, for example a base station of a radio access network, and transmit or receive, or transmit and receive communications on the carrier.

A communication system and associated compatible terminals typically operate in accordance with a given standard or specification which sets out what various network entities of the communication system are permitted to do and how that should be achieved. Communication protocols, or parameters, or protocols and parameters which shall be used for communications are also typically defined. One example of a communications system is a Universal Mobile Telecommunications System (UMTS) system (e.g., a communication system using 3G radio access technology). Other examples of communication systems are so called 4G systems (e.g., communication systems operating using 4G radio access technology) and 5G or New Radio (NR) systems (e.g., communication systems operating using 5G or NR radio access technology). Radio access technologies that are used by communication systems are standardized by the 3rd Generation Partnership Project (3GPP).

### SUMMARY

According to an aspect, there is provided a method for an apparatus for a mobile network, the method comprising: receiving a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; selecting, for a multi-access data session, at least two access paths from the plurality of access paths based on the policy information; and requesting establishment of a multi-access data session comprising the selected at least two access paths, the selected at least two access paths being over the at least two accesses operating according to the first standard or at least two accesses operating according to the further standard.

The at least two accesses operating according to a first standard may be 3GPP accesses and the at least two accesses operating according to a further standard may be non-3GPP accesses.

The policy information comprising policy information indicating preferences regarding which accesses paths from a plurality of access paths are to be established for a multi-access data session for application traffic may comprise at least one of: a description of the application traffic; an identifier identifying an access path over which the apparatus is registered with the mobile network; an identifier identifying a type of an access; an identifier identifying a radio access technology of the access; a combination of a source IP address, a destination IP address, a source port number, a destination port number, and a protocol of the multiple access data session; an identifier identifying the mobile network; and an identifier identifying a network operator of the mobile network.

The identifier identifying the mobile network may comprise at least one of: an identifier identifying a public land mobile network; and an identifier identifying a standalone non-public network.

Selecting, for the multi-access data session, at least two access paths from the plurality of access paths based on the policy information may comprise selecting the at least two access paths from the plurality of access paths that: correspond to access paths identified within the policy information; and via which the apparatus is registered with the mobile network.

Selecting, for the multi-access data session, at least two access paths from the plurality of access paths based on the policy information may comprise selecting at least two access paths from a plurality of access paths that correspond to access paths identified within the policy information.

Requesting establishment of a multi-access data session comprising the selected at least two access paths may further comprise requesting registration with the mobile network over at least one of the accesses on which the selected at least two access paths are to be established; and requesting establishment of the selected at least two access paths.

The policy may comprise a user equipment route selection policy, and the policy information may be a route selection descriptor component type identifier comprising the preferences on which access paths from the plurality of access paths the multi-access data session is to be established.

The route selection descriptor component type identifier may comprise one octet indicating a number of multi-access preference fields followed by octets of the multi-access preference fields, wherein the octet of the multi-leg preference field may comprise at least one of: an indicator indicating a type of access; an indicator indicating a radio access technology; a registration identity corresponding to a registration to the mobile network over the access; an indicator indicating a preference for selecting a public land mobile network or a standalone non-public network; and an indicator indicating a preference for barring selection of a public land mobile network or a standalone non-public network.

Receiving the policy, the policy comprising policy information indicating preferences regarding which accesses paths from a plurality of access paths are to be established for a multi-access data session for application traffic comprises receiving the policy information via one of: control plane signalling; and user plane signalling.

The policy information may comprise user subscription information indicating a multi-access data session can be requested to be established by the apparatus over at least one of: a defined type of access; and a defined radio access technology, wherein the multi-access data session is for at least one of: a defined single-network slice selection assistance information; and a defined data network name.

The method may further comprise requesting, for the multi-access data session, a release of at least one access path of the selected at least two access paths.

Requesting for the multi-access data session, a release of one access path of the selected at least two access paths may comprise requesting the release of the one access path based on a determination of a substantial loss of connectivity to an access network in the one access path.

According to a second aspect there is provided a method for an apparatus for a mobile network, the method comprising: generating a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; and sending the policy to a further apparatus configured to register with the mobile network.

The at least two accesses operating according to a first standard may be 3GPP accesses and the at least two accesses operating according to a further standard may be non-3GPP accesses.

The policy information indicating preferences regarding which accesses paths from a plurality of access paths are to be established for a multi-access data session for application traffic may comprise, for each access path, at least one of: a description of the application traffic using the multi-access data session; an identifier identifying an access via which the further apparatus is registered; an identifier identifying a type of an access; an identifier identifying a radio access technology of the access; a combination of a source IP address, a destination IP address, a source port number, a destination port number, and a protocol of the multiple access data session; an identifier identifying a mobile network the access path is in (or belongs to); and an identifier identifying a network operator of a mobile network the access path is in (or belongs to).

The identifier identifying the network may comprise at least one of: an identifier identifying a public land mobile network; an identifier identifying a standalone non-public network.

The method may further comprise: receiving a request from the further apparatus for the establishment of the multi-access data session over the at least two accesses operating according to the first standard or at least two accesses operating according to the further standard; and establishing the multi-access data session over the at least two accesses operating according to the first standard or at least two accesses operating according to the further standard based on the received request.

The method may further comprise: receiving a request for registration of the further apparatus to the mobile network over the at least two accesses operating according to the first standard or the at least two accesses operating according to the further standard; and registering the further apparatus with the mobile network over the at least two accesses operating according to the first standard or the at least two accesses operating according to the further standard based on the received request.

The policy may comprise a user equipment route selection policy, the policy information may be a route selection descriptor component type identifier comprising the preferences on which access path from the plurality of access paths of the communications network the multi-access data session is to be established.

The route selection descriptor component type identifier may comprise one octet indicating a number of multi-access preference fields followed by octets of the multi-access preference fields, wherein the octet of the multi-leg preference field may comprise at least one of: an indicator indicating a type of access; an indicator indicating a radio access technology; a registration identity corresponding to a registration to the mobile network over the access; an indicator indicating a preference for selecting a public land mobile network or a standalone non-public network; and an indicator indicating a preference for barring selection of a public land mobile network or a standalone non-public network.

Sending the policy to a further apparatus may comprise sending the policy information via one of: control plane signalling; and user plane signalling.

The policy information may comprise user subscription information indicating a multi-access data session can be requested to be established by the further apparatus over at least one of: a defined type of access; and a defined radio access technology, wherein the multi-access data session is for at least one of: a defined single-network slice selection assistance information; and a defined data network name.

The method may further comprise receiving a request for a release of at least one access path of the selected at least two access paths of the multi-access data session; and granting the release of at least one access path of the selected at least two access paths of the multi-access data session.

According to a third aspect there is provided an apparatus for a mobile network, the apparatus comprising means for: receiving a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; selecting, for a multi-access data session, at least two access paths from the plurality of access paths based on the policy information; and requesting establishment of a multi-access data session comprising the selected at least two access paths, the selected at least two access paths being over the at least two accesses operating according to the first standard or at least two accesses operating according to the further standard.

The at least two accesses operating according to a first standard may be 3GPP accesses and the at least two accesses operating according to a further standard may be non-3GPP accesses.

The policy information indicating preferences regarding which accesses paths from a plurality of access paths are to be established for a multi-access data session for application traffic may comprise, for each access path, at least one of: a description of the application traffic using the multi-access data session; an identifier identifying an access via which the apparatus is registered with the communication network; an identifier identifying a type of the access; an identifier identifying a radio access technology of the access; a combination of a source IP address, a destination IP address, a source port number, a destination port number, and a protocol of the multiple access data session; an identifier identifying a mobile network the access path is in (or belongs to); and an identifier identifying a network operator of a mobile network the access path is in (or belongs to).

The identifier identifying the network may comprise at least one of: an identifier identifying a public land mobile network; and an identifier identifying a standalone non-public network.

The means for selecting, for the multi-access data session, at least two access paths from the plurality of access paths based on the policy information may be means for selecting the at least two access paths from the plurality of access paths that: correspond to access paths identified within the policy information; and via which the apparatus is registered to the mobile network.

The means for selecting, for the multi-access data session, at least two access paths from the plurality of access paths based on the policy information may be means for selecting at least two access paths from a plurality of access paths that correspond to access paths identified within the policy information.

The means for requesting the establishment of the multi-access data session comprising the selected at least two access paths may be means for requesting registration with the mobile network over at least one of the selected at least two access paths; and requesting establishment of the multi-access data session over the at least one of the selected at least two access paths.

The policy may comprise a user equipment route selection policy, and the policy information may be a route selection descriptor component type identifier comprising the preferences on which access paths from the plurality of access paths of the communications network the multi-access data session is to be established.

The route selection descriptor component type identifier may comprise one octet indicating a number of multi-access preference fields followed by octets of the multi-access preference fields, wherein the octet of the multi-leg preference field may comprise at least one of: an indicator indicating a type of access; an indicator indicating a radio access technology; a registration identity corresponding to a registration to the mobile network over the access; an indicator indicating a preference for selecting a public land mobile network or a standalone non-public network; and an indicator indicating a preference for barring selection of a public land mobile network or a standalone non-public network.

The means for receiving the policy comprising information indicating preferences regarding which accesses paths from a plurality of access paths are to be established for a multi-access data session for application traffic may be means for receiving the policy information via one of: control plane signalling; and user plane signalling.

The policy information may comprise user subscription information indicating a multi-access data session can be requested to be established by the apparatus over at least one of: a defined type of access; and a defined radio access technology, wherein the multi-access data session is for at least one of: a defined single-network slice selection assistance information; and a defined data network name.

The means may be further for requesting, for the multi-access data session, a release of at least one of the selected at least two access paths.

The means for requesting for the multi-access data session, a release of at least one of the selected at least two access paths may be for requesting the release of the at least one of the selected at least two access paths based on a determination of a substantial loss of connectivity to one of the selected at least two access paths.

According to a fourth aspect there is provided an apparatus for a mobile network, the apparatus comprising means for: generating a policy, the policy comprising information indicating preferences regarding which accesses paths from a plurality of access paths are to be established for a multi-access data session for application traffic, the plurality of access paths being over at least two accesses operating according to a first standard or at least two accesses operating according to a further standard; and sending the policy to a further apparatus registered with the mobile network.

The at least two accesses operating according to a first standard may be 3GPP accesses and the at least two accesses operating according to a further standard may be non-3GPP accesses.

The policy information indicating preferences regarding which accesses paths from a plurality of access paths are to be established for a multi-access data session for application traffic may comprise, for each access path, at least one of: a description of the application traffic using the multi-access data session; an identifier identifying an access via which the further apparatus is registered; an identifier identifying a type of an access; an identifier identifying a radio access technology of the access; a combination of a source IP address, a destination IP address, a source port number, a destination port number, and a protocol of the multiple access data session; an identifier identifying a mobile network the access path is in (or belongs to); and an identifier identifying a network operator of the mobile network the access path is in (or belongs to).

The identifier identifying the network may comprise at least one of: an identifier identifying a public land mobile network; an identifier identifying a standalone non-public network.

The means may be further for: receiving a request from the further apparatus for the establishment of the multi-access data session over the at least two accesses operating according to the first standard or at least two accesses operating according to the further standard; and establishing the multi-access data session over the at least two access networks operating according to the first standard or at least two access operating according to the further standard based on the received request.

The means may be further for: receiving a request for registration of the further apparatus to the mobile network over the at least two accesses operating according to the first standard or the at least two accesses operating according to the further standard; and registering the further apparatus to the mobile network over the at least two accesses operating according to the first standard or the at least two accesses operating according to the further standard based on the received request.

The policy may comprise a user equipment route selection policy, the policy information may be a route selection descriptor component type identifier comprising the preferences on which access paths from the plurality of access paths the multi-access data session is to be established.

The route selection descriptor component type identifier may comprise one octet indicating a number of multi-access preference fields followed by octets of the multi-access preference fields, wherein the octet of the multi-leg preference field may comprise at least one of: an indicator indicating a type of access; an indicator indicating a radio access technology; a registration identity corresponding to a registration to the communication network over the access; an indicator indicating a preference for selecting a public land mobile network or a standalone non-public network; and an indicator indicating a preference for barring selection of a public land mobile network or a standalone non-public network.

The means for sending the policy to a further apparatus may be means for sending the policy information via one of: control plane signalling; and user plane signalling.

The policy information may comprise user subscription information indicating a multi-access data session can be requested to be established by the further apparatus over at least one of: a defined type of access; and a defined radio access technology, wherein the multi-access data session is for at least one of: a defined single-network slice selection assistance information; and a defined data network name.

The means may be further for: receiving a request for a release of at least one access path of the selected at least two access paths for the multi-access data session; and granting the release of at least one access path of the selected at least two access paths for the multi-access data session.

According to a fifth aspect there is provided an apparatus for a mobile network, the apparatus comprising at least one processor and at least one memory storing instructions that, when executed by the at least one processor, cause the apparatus at least to perform: receiving a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; selecting, for a multi-access data session, at least two access paths from the plurality of access paths based on the policy information; and requesting establishment of a multi-access data session over the selected at least two access paths, the selected at least two access paths being over the at least two accesses operating according to the first standard or at least two accesses operating according to the further standard.

The at least two accesses operating according to a first standard may be 3GPP accesses and the at least two accesses operating according to a further standard may be non-3GPP accesses.

The policy information indicating preferences regarding which accesses paths from a plurality of access paths are to be established for a multi-access data session for application traffic may comprise, for each access path, at least one of: a description of the application traffic using the multi-access data session; an identifier identifying an access via which the apparatus is registered with the communication network; an identifier identifying a type of an access; an identifier identifying a radio access technology of the access; a combination of a source IP address, a destination IP address, a source port number, a destination port number, and a protocol of the multiple access data session; an identifier identifying a mobile network the access path is in (or belongs to); and an identifier identifying a network operator of the mobile network the access path is in (or belongs to).

The identifier identifying the network may comprise at least one of: an identifier identifying a public land mobile network; and an identifier identifying a standalone non-public network.

The apparatus caused to perform selecting, for the multi-access data session, at least two access paths from the plurality of access paths based on the policy information may be caused to perform selecting the at least two access paths from the plurality of access paths that: correspond to access paths identified within the policy information; and via which the apparatus is registered to the communication network.

The apparatus caused to perform selecting, for the multi-access data session, at least two access paths from the plurality of access paths based on the policy information may be caused to perform selecting at least two access networks from a plurality of access networks that correspond to access paths identified within the policy information.

The apparatus caused to perform requesting the establishment of the multi-access data session over the selected at least two access paths may be caused to perform: requesting registration to the communication network over at least one of the selected at least two access paths; and requesting establishment of the multi-access data session over the at least one of the selected at least two access paths.

The policy may comprise a user equipment route selection policy, and the policy information may be a route selection descriptor component type identifier comprising the preferences on which access paths from the plurality of access paths of the communications network the multi-access data session is to be established.

The route selection descriptor component type identifier may comprise one octet indicating a number of multi-access preference fields followed by octets of the multi-access preference fields, wherein the octet of the multi-leg preference field may comprise at least one of: an indicator indicating a type of access network; an indicator indicating a radio access technology; a registration identity corresponding to a registration to the communication network over the access path; an indicator indicating a preference for selecting a public land mobile network or a standalone non-public network; and an indicator indicating a preference for barring selection of a public land mobile network or a standalone non-public network.

The apparatus caused to perform receiving the policy, the policy comprising indicating preferences regarding which accesses paths from a plurality of access paths are to be established for a multi-access data session for application traffic may be caused to perform receiving the policy information via one of: control plane signalling; and user plane signalling.

The policy information may comprise user subscription information indicating a multi-access data session can be requested to be established by the apparatus over at least one of: a defined type of access network; and a defined radio access technology, wherein the multi-access data session is for at least one of: a defined single-network slice selection assistance information; and a defined data network name.

The apparatus may be further caused to perform requesting, for the multi-access data session, a release of at least one of the selected at least two access paths.

The apparatus caused to perform requesting for the multi-access data session, a release of at least one of the selected at least two access paths may be caused to perform requesting the release of the at least one of the selected at least two access paths based on a determination of a substantial loss of connectivity to one of the selected at least two access paths.

According to a sixth aspect there is provided an apparatus for a communication network, the apparatus comprising at least one processor and at least one memory storing instructions that, when executed by the at least one processor, cause the apparatus at least to perform: generating a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; and sending the policy to a further apparatus configured to register with the mobile network.

The at least two access networks operating according to a first standard may be 3GPP accesses and the at least two accesses operating according to a further standard may be non-3GPP accesses.

The policy information indicating preferences regarding which accesses paths from a plurality of access paths are to be established for a multi-access data session for application traffic may comprise, for each access path, at least one of: a description of the application traffic using the multi-access data session; an identifier identifying an access via which the device is registered; an identifier identifying a type of an access; an identifier identifying a radio access technology of the access; a combination of a source IP address, a destination IP address, a source port number, a destination port number, and a protocol of the multiple access data session; an identifier identifying a mobile network; and an identifier identifying a network operator of the mobile network.

The identifier identifying the mobile network may comprise at least one of: an identifier identifying a public land mobile network; an identifier identifying a standalone non-public network.

The apparatus may be further caused to perform: receiving a request from the further apparatus for the establishment of the multi-access data session over the at least two access networks operating according to the first standard or at least two access networks operating according to the further standard; and establishing the multi-access data session over the at least two access networks operating according to the first standard or at least two access networks operating according to the further standard based on the received request.

The apparatus may be further caused to perform: receiving a request for registration of the further apparatus to the communication network over the at least two access networks operating according to the first standard or the at least two access networks operating according to the further standard; and registering the further apparatus to the communication network over the at least two access networks operating according to the first standard or the at least two access networks operating according to the further standard based on the received request.

The policy may comprise a user equipment route selection policy, the policy information may be a route selection descriptor component type identifier comprising the preferences on which access path from the plurality of access paths of the communications network the multi-access data session is to be established.

The route selection descriptor component type identifier may comprise one octet indicating a number of multi-access preference fields followed by octets of the multi-access preference fields, wherein the octet of the multi-leg preference field may comprise at least one of: an indicator indicating a type of access network; an indicator indicating a radio access technology; a registration identity corresponding to a registration to the communication network over the access network; an indicator indicating a preference for selecting a public land mobile network or a standalone non-public network; and an indicator indicating a preference for barring selection of a public land mobile network or a standalone non-public network.

The apparatus caused to perform sending the policy to a further apparatus may be caused to perform sending the policy information via one of: control plane signalling; and user plane signalling.

The policy information may comprise user subscription information indicating a multi-access data session can be requested to be established by the further apparatus over at least one of: a defined type of access network; and a defined radio access technology, wherein the multi-access data session is for at least one of: a defined single-network slice selection assistance information; and a defined data network name.

The apparatus may be further caused to perform: receiving a request for a release of at least one access path over the selected at least two access paths for the multi-access data session; and granting the release of at least one access path over the selected at least two access paths for the multi-access data session.

According to a seventh aspect, there is provided an apparatus for a mobile network, the apparatus comprising: means for receiving a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; means for selecting, for a multi-access data session, at least two access paths from the plurality of access paths based on the policy information; and means for requesting establishment of a multi-access data session comprising the selected at least two access paths, the selected at least two access paths being over the at least two accesses operating according to the first standard or at least two accesses operating according to the further standard.

According to an eighth aspect, there is provided an apparatus for a mobile network, the apparatus comprising: means for generating a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; and means for sending the policy to a further apparatus registered with the mobile network.

According to a ninth aspect, there is provided an apparatus for a mobile network, the apparatus comprising: receiving circuitry configured to receive a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; selecting circuitry configured to select, for a multi-access data session, at least two access paths from the plurality of access paths based on the policy information; and requesting circuitry configured to request establishment of a multi-access data session comprising the selected at least two access paths, the selected at least two access paths being over the at least two accesses operating according to the first standard or at least two accesses operating according to the further standard.

According to a tenth aspect, there is provided an apparatus for a mobile network, the apparatus comprising: generating circuitry configured to generate a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; and sending circuitry configured to send the policy to a further apparatus registered with the mobile network.

According to an eleventh aspect, there is provided a computer program comprising instructions [or a computer readable medium comprising instructions] for causing an apparatus for a communication network, to perform at least the following: receiving a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; selecting, for a multi-access data session, at least two access paths from the plurality of access paths based on the policy information; and requesting establishment of a multi-access data session comprising the selected at least two access paths, the selected at least two access paths being over the at least two accesses operating according to the first standard or at least two accesses operating according to the further standard.

According to a twelfth aspect, there is provided a computer program comprising instructions [or a computer readable medium comprising instructions] for causing an apparatus for a mobile network, to perform at least the following: generating a policy, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard; and sending the policy to a further apparatus registered with the mobile network.

According to a thirteenth aspect, there is provided a non-transitory computer readable medium comprising program instructions for causing an apparatus for a communication network to perform at least the following: receiving a policy, the policy comprising policy information indicating preferences on which access paths from a plurality of access paths of a multi-access data session for application traffic is to be established, the plurality of access paths being over at least two accesses operating according to a first standard or at least two accesses operating according to a further standard; selecting, for a multi-access data session, at least two access paths from the plurality of access paths based on the policy information; and requesting establishment of a multi-access data session comprising the selected at least two access paths, the selected at least two access paths being over the at least two accesses operating according to the first standard or at least two accesses operating according to the further standard.

According to a fourteenth aspect, there is provided a non-transitory computer readable medium comprising program instructions for causing an apparatus for a mobile network to perform at least the following: generating a policy, the policy comprising information indicating preferences regarding which accesses paths from a plurality of access paths are to be established for a multi-access data session for application traffic, the plurality of access paths being over at least two accesses operating according to a first standard or at least two accesses operating according to a further standard; and sending the policy to a further apparatus registered with the communication network.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a mobile network according to some example embodiments;

FIG. 2 shows a representation of an apparatus implementing one or more network functions of a core network according to some example embodiments;

FIG. 3 shows a representation of an apparatus according to some example embodiments;

FIG. 4 shows a flow diagram of a procedure for establishment of a multi-data session comprising multiple legs over multiple access of the same access type in a mobile network according to an example embodiment;

FIG. 5 shows a flow diagram of a procedure for establishment of a multi-data session comprising multiple legs over multiple access of the same access type in a mobile network according to some other example embodiment; and

FIG. 6 shows a flow diagram of a procedure for establishment of a multi-data session comprising multiple legs over multiple access of the same access type in a mobile network according to another example embodiment.

### DETAILED DESCRIPTION

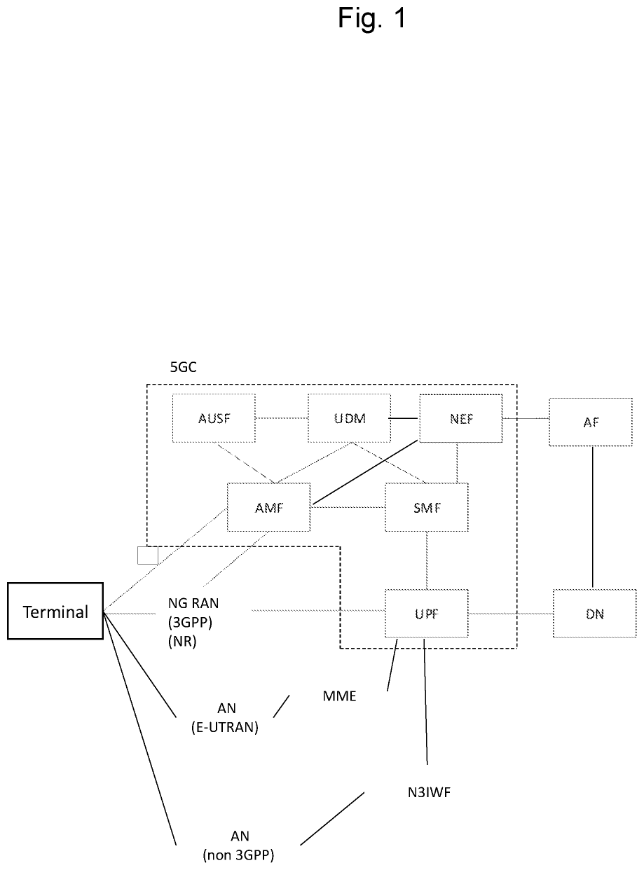

In the following certain embodiments are explained with reference to apparatuses capable of communication with a communication system serving such apparatuses. Before explaining in detail the exemplifying embodiments, certain general principles of a communication system, for example a 5G communication system, that can include one or more access network (AN) and a core network, and apparatuses (e.g., terminals served by the communication system are briefly explained with reference to FIGS. 1, 2 and 3 to assist in understanding the technology underlying the described examples.

FIG. 1 shows a schematic representation of a mobile network according to an example embodiment of the present disclosure. The mobile network comprises a 5G wireless communication system (5GS) and components of an evolved packet system (EPS). The 5GS may be comprised of access networks (ANs) and a 5G core network (5GC). An access network of the 5GS may comprise a 3GPP access network, such as a 5G radio access network (5G-RAN) also called next generation radio access network (NG-RAN). A 5G-RAN or NG-RAN may include a terrestrial network (TN) and/or a non-terrestrial network (NTN). An AN of the 5GS may alternatively comprise a non-3GPP access network. Examples of non-3GPP access networks 103 include an untrusted wireless local area network (WLAN) which can access the 5GC via a non-3GPP Interworking Function (N3IWF), a trusted WLAN which accesses the 5GC via a Trusted non-3GPP Gateway Function (TNGF), a wireline network which accesses the 5GC via a Wireline Access Gateway function (W-AGF)).

In some embodiments, an AF, which is a customer of the 5GC, is connected to a user plane function (UPF) of the 5GC via a DN and to various network functions (NFs) of the 5GC via a network exposure function (NEF) of the 5GC. In some embodiments, the AF is a trusted application function and hence the trusted AF is implemented in the 5GC and connected to directly to other NFs of the 5GC. It will be appreciated that although only one UPF is shown in FIG. 1, the 5GS may be composed of a chain of UFPs that include a UPF anchor that connects to the DN. The AF may, transmit to and receive from the various NFs of the 5GC, control plane signalling directly or via the NEF. The AF may also transmit user plane traffic to and receive user plane traffic from the anchor UPF of the 5GC via the DN. The connections between elements drawn in FIG. 1, are via interfaces defined in TS 23.501 and 23.502 of the 3GPP standard. The mobile network as shown in FIG. 1 can also comprise components of an EPC, including another access network (AN) 105, for example a 4G radio access network (generally referred to as a E-UTRAN). The E-UTRAN is connected to an MME (Mobile Management Entity) of the EPC of the mobile network. The MME transmits control plane signalling that enables low-level connection management. The MME communicates with a eNodeB of the AN 105 using a S1-MME interface. The MME is responsible for example NAS layer signalling (Non-Access Stratum), user authentication and authorization, support for connecting terminals (e.g., UEs) to the EPC, setting and managing bearers, selection of PGW and SGW for a given connection, selection of a different MME when switching between eNodeBs, TA (Tracking Area) management, roaming support and SGW. Additionally in FIG. 1 is shown the SGW (Serving Gateway) which transfers user plane traffic from the another AN 105 (e.g.-E-UTRAN) to the UPF via the SGW. The SGW is responsible for routing user plane traffic, forwarding user plane traffic, packet marking of packets and buffering, user mobility management, and for handing over connections between two eNodeBs.

The 5GC may comprise for instance the following network functions (NFs) (otherwise referred to as network entities): Network Slice Selection Function (NSSF); Network Exposure Function (NEF); Network Repository Function (NRF); Network Data Analytics Function (NWDAF), Policy Control Function (PCF); Unified Data Management (UDM); Authentication Server Function (AUSF); an Access and Mobility Management Function (AMF); a Session Management Function (SMF) and User Plane Function (UPF). The NFs of the 5GC may have a service-based architecture as described in TS 23.501 of the 3GPP standard. NF services that may be offered by the NFs of the 5GC and service-based interfaces for the NFs of the 5GC are described in 3GPP standard, and in particular in TS 23.501 and 23.502 of the 3GPP standard.

Terminals, such as the terminal in FIG. 1, can support (i.e., are capable of) registering with the 5GC of the mobile network over one or more accesses using a registration procedure. When the terminal (e.g., a UE) triggers a registration procedure to register with a 5GC over an access, the terminal (e.g., a UE) generates a registration request to register with the 5GC and sends the registration request to an access network. The access network sends the received registration request together with an indication of an access type of the access network to an AMF of the 5GC. The access type can be 3GPP access or non-3GPP access. Hence, the indication of the access type sent by the access to the AMF indicates to the AMF that the terminal (e.g., UE) is registering with the AMF of the 5GC through either a 3GPP access network or a non-3GPP access network. The AMF of the 5GC responds to the registration request with a registration accept message when the AMF accepts the UE's registration request and registers the terminal (e.g., UE) with the 5GC. The registration accept message indicates that the terminal (e.g., UE) is registered in the mobile network over an access. In some embodiments, the registration request may be a NAS signalling message or may be included in a NAS signalling message and the registration accept may be a NAS signalling message or may be included in a NAS signalling message. The registration request may comprise an indication of capabilities of the terminal (e.g., UE), an indication of a network slice to be accessed, and an identifier of the terminal (e.g., UE).

In the example shown in FIG. 1, when the terminal (e.g., UE) triggers a registration procedure to register with the AMF of the 5GC of the mobile network, the terminal (e.g., UE) sends a registration request to the 3GPP access network 101 (e.g., a 5G radio access network (5G-RAN) (also called next generation radio access network (NG-RAN)) which sends the registration request together with an indication of the access type of the 3GPP access network 101 to the AMF as described above. The 5G-RAN (otherwise referred to as a NG-RAN) may comprise one or more base stations (e.g., gNodeBs (gNBs)). The gNBs of the 5G-RAN may include a gNB distributed unit connected to a gNB central unit, and remote radio heads connected to the gNB distributed units. The 5G-RAN may also comprise an NTN comprising multiple satellites which may be located in various orbits, for example, low earth orbit (LEO), medium earth orbit (MEO), geostationary earth orbit (GEO). The AMF accepts the terminals (UEs) registration request and sends a registration accept message to the terminal (e.g., UE) which indicates that the terminal (e.g., UE) is registered with the AMF over 3GPP access. In the present disclosure, a terminal (e.g., UE) that registered over 3GPP access refers to a terminal (e.g., UE) that is registered with an AMF of a 5GC via a 3GPP access network. A 3GPP access network can employ any radio access technology, such as 3G, LTE, NTN, or 5G (otherwise referred to as NR).

In some embodiments, terminals (e.g., UE), such as the terminal (e.g., UE) shown in FIG. 1, may support (i.e., may be capable of) registering with the MME of the mobile network over 3GPP access. In these embodiments, the terminal (e.g., UE) may register with the MME over 3GPP access by sending a registration request to the MME via a 3GPP access network 105 (e.g., a E-UTRAN) and a connection between the 3GPP access network 105 (e.g., E-UTRAN) and the MME. The 3GPP access network 105 (e.g., E-UTRAN) may comprises one or more base stations (e.g., Evolved NodeB also known as eNodeB (eNB).

Furthermore, the terminal (e.g., UE) may support (i.e., may be capable) of registering with the AMF of the 5GC over non-3GPP access. In these embodiments, the terminal (e.g., UE) may register with the AMF of the 5GC over non-3GPP access by sending a registration request to the AMF via a via an access path comprising a non-3GPP access network 103, an interworking function, a connection between the non-3GPP access network 103 and the interworking function and the interworking function and the AMF. The non-3GPP access network 103 may be any wireless or wired access network. The interworking function may be a N3IWF, a TNFG, or a W-AGF. In the present description, a terminal (e.g., UE) that registered over non-3GPP access refers to a terminal (e.g., UE) that is registered with an AMF of a 5GC via a non-3GPP access network and an interworking function (e.g., a N3IWF, a TNFG, or a W-AGF).

The 5GS supports certain functionalities to provide multi-access data connectivity to a UE at upper layers of the 5G protocol stack (in other words the layers above the media access control layer). In other words, the 5GS supports (i.e., is capable of) establishing a data session over multiple accesses (i.e., a multi-access data session over more than two accesses) for exchanging user plane traffic between the terminal (e.g., a UE) and a data network (DN) simultaneously. However, the current 3GPP specifications limit a 5GS to provisioning a 5GC with functionalities to support establishment of a multi-access data session over one 3GPP access and one non-3GPP access only.

It is desired for procedures for establishment of a multi-access data session (e.g., a multi-access PDU session) that provides a PDU connectivity service which can simultaneously access more than one 3GPP access network and/or more than one non-3GPP access network (in one mobile network or in two different mobile networks). In other words, it is desired for procedures for establishment of a multi-access data session comprising multiple legs over multiple 3GPP accesses or multiple non-3GPP accesses, where the multiple 3GPP accesses may have the same radio access technology (RAT) or different RATs.

In some embodiments, a procedure for establishment of a multi-access data session comprising multiple legs over multiple accesses of the same access type comprise a terminal (e.g., UE) requesting creation of a multi-access data session comprising multiple legs over multiple accesses having the same access type. In this embodiment, a leg of the MA PDU session is established over each access of the multiple access of the same type. In some embodiments, a procedure for establishment of a multi-access data session comprising multiple legs over multiple accesses of the same access type comprises a terminal (e.g., a UE) requesting modification of an existing PDU session comprising one leg over one access having an access type to establish another leg over another access having the same access type as the one access. Establishment of a leg (otherwise referred to an access path) over an access refers to providing end-to-end connectivity between the terminal (e.g., UE) and a user plane function through the access network of the access.

In the following examples, a terminal (e.g., UE) may be registered with a core network over multiple accesses and the terminal (e.g., UE) may request establishment of a multi-access data session comprising multiple legs over at least two of the accesses having the same access type (or the same radio access technology (RAT)).

In a first example, the terminal (e.g., the UE) is registered with a core network over a first access comprising a 5G non-terrestrial access network (e.g., a 3GPP NTN) which may be part of a first mobile network (e.g., PLMN1). The terminal (e.g., UE) is also registered with the core network over a second access comprising a 5G terrestrial access network (e.g., a 3GPP NG-RAN) which is part of the same mobile network (PLMN1) that the first access is part of. In this first example the first and second accesses are in the same mobile network, have a same access type (3GPP access), and have different RATs (NTN vs NR).

In a second example, the terminal (e.g., the UE) is registered with a core network over a first access comprising a 5G terrestrial access network (e.g., a 3GPP NG-RAN) which is part of first mobile network (e.g., PLMN1). The terminal (e.g., UE) is also registered with the core network over a second access comprising a LTE terrestrial access network (e.g., 3GPP E-UTRAN) which is part of the same mobile network (PLMN1). In this example of the first and second accesses are in the same mobile network, have a same access type (3GPP access) and have different RATs (NR vs LTE).

In a third example, the terminal (e.g., the UE) is registered with a core network over a first access comprising a 5G terrestrial access network (e.g., a 3GPP NG-RAN) which is part of a first mobile network (PLMN1). The terminal (e.g., UE) is also registered with the core network over a second access comprising a 5G terrestrial access network (e.g., a 3GPP NG-RAN) which is part of a second mobile network (PLMN2). In this example, the first and second accesses are in different mobile networks, have the same access type (3GPP access), and have the same RAT (NR).

In a fourth example, the terminal (e.g., the UE) is registered with a core network over a first access comprising a non-3GPP access network and a N3IWF which are part of a first network (PLMN1). The terminal (e.g., UE) is also registered over a second access comprising a non-3GPP access network and another N3IWF which is part of a second network (PLMN2). In this fourth example, the first and second access are in two different mobile networks and have the same access type (non-3GPP access).

Other examples can include procedures for establishment of a multi-access data session comprising multiple legs over multiple accesses, where the multiple accesses have a same access type, different access types, and/or same or different RATs. For example, a procedure for establishing a multi-access data session comprising multiple legs over multiple accesses may result is a multi-access data session comprising two legs over two 3GPP accesses, where the two 3GPP accesses have the same RAT, for example NR and NR or NTN and NTN, or different RATs, for example NR and LTE.

Enabling a UE to request establishment of multi-access data session comprising multiple legs over multiple different accesses where the accesses have different access types and different RATs could improve transmission of user plane traffic from the UE to a data network because the established MA PDU session would have multiple legs over varied access over which to transmit the user plane traffic to the data network. Additionally establishment of a multi-access data session comprising multiple legs over multiple accesses having a wide range of different RATs, and access types could improve network resource utilization. This utilization can be measured in terms of resource and performance indicators associated with access networks of the accesses, such as capacity (defining how much of a resource such as available bandwidth remains unutilized), coverage (defining the range or scope or area within which a UE is able to access the mobile network(s)), reliability (defining the dependability of the access network) and Quality of Experience (QoE) (which can be a multi-factor based measurement of the access network comprising factors such as reliability, capacity, network delay, throughput etc). Network resources and the performance indicators such as described above are explained in further detail in such documents as 3GPP TS 23.501, TS 23.502, TS 24.501, TS 24.526 and TS 24.501.

A practical example of improving transmission of user plane traffic from the UE to a data network may be in railway communications that require an extreme reliability of the communications.

For example, when UE is registered with a core network of a mobile network (e.g., a PLMN) over a first access comprising a first access network that is a terrestrial access network (TN) and over a second access comprising a second access network that is a non-terrestrial network (NTN), extra resources available in the second access network (i.e., the NTN) can be used to extend capacity, or throughput, or capacity and throughput of user plane traffic transmitted through the first access network (i.e., the TN), or vice versa. The transmission of user plane traffic over a wide range of different access networks, RATs, and access types can be based on demand for network resources (for example for greater network bandwidth, or a lower average latency for the MA data session etc or to switch immediately from one leg of the MA data session to another leg of the data session when there is failure or overload over the first access) or the provision of temporary coverage (for example to increase or augment network capacity in relation to an emergency situation). For example, a terminal (e.g., a UE) located in a train, cruise-ship, or plane served normally by NTN, which is arriving at a stopover (where dual coverage from the NTN and a TN is available can be configured to use traffic aggregation to lower average latency or increase bandwidth of a (multi-access) data session.

Another example could be when a terminal (e.g., a UE) is located in a car that is normally served by a TN becomes stuck in heavy traffic following a serious accident. In this example the terminal (e.g., UE) may enable transmission of user plane traffic over a wide range of different legs of a multi-access data session to ensure that bandwidth for a multi-access data session does not fall to an unacceptable level (because of the significant numbers of other terminals (e.g., UEs in other cars being located in the same physical area as the terminal (e.g., the UE) by using traffic aggregation over the TN and further access networks such as a NTN.

A further example would be the ability for the UE or the UPF, or the UE and the UPF to use traffic aggregation on user plane traffic received over multiple leg over multiple accesses, where each access comprises satellite access (in the same or different mobile network (e.g., PLMN). In other words, there are two or more accesses in the same or different mobile networks provided by two or more different satellite constellations or satellite access networks. This could for example provide an expanded bandwidth or throughput or bandwidth and throughput when compared to a single leg comprising a single satellite access network. Furthermore in some examples, different types of satellite access networks can be employed to provide advantages such as application delay or latency (for example by switching from a GEO access network to LEO access network to reduce latency), or coverage improvements (for example by switching from a LEO access network to GEO access network to prevent coverage or access loss as the LEO satellite coverage can vary significantly over time as satellites within the satellite access network rise above and drop below the horizon while a GEO satellite provides constant accessibility.

A further example of an improvement which could be achieved based on the embodiments as discussed herein could be a dual-terrestrial access network example, where there is a deployed a wide area access network in a first mobile network (which for example can be designated PLMN1 or NPN1) and a local access network in a second mobile network (which for example can be designated PLMN2 or NPN2) for a specific areas or premises, e.g., in a stadium. In this example during high-data traffic events, available resources from the local access network in the second mobile network (PLMN2 or NPN2) can be used to provide extra capacity to the wide-area access network in the first mobile network (PLMN1 or NPN1), or vice versa. This example can apply in other environments, e.g., campus, enterprise, factory, home.

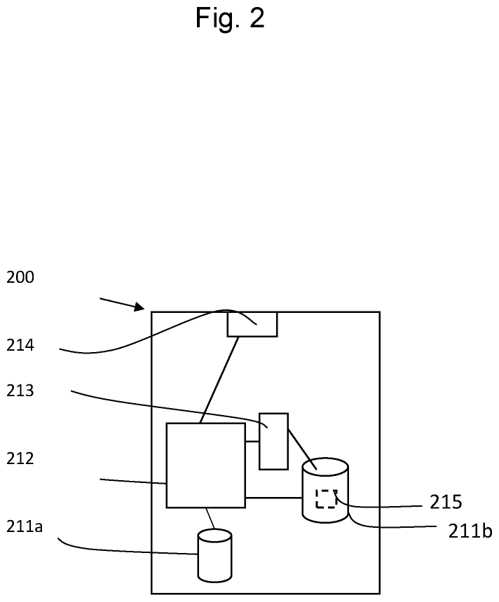

FIG. 2 illustrates an example of an apparatus 200 that may implement one or more NFs of the 5GC illustrated in FIG. 1. The apparatus 200 may comprise at least one random access memory (RAM) 211a, at least one read only memory (ROM) 211b, at least one processor 212, 213 and a network interface 214. The at least one processor 212, 213 may be coupled to the RAM 211a and the ROM 211b. The at least one processor 212, 213 may be configured to execute software code 215. The software code 215 may for example include instructions to perform actions or operations of one or more NFs of the 5GC, including actions or operations of a policy control function (PCF). In some embodiments, the software code 215 may include actions or operations for generating a UE policy for a UE that is registered with the 5GC. The UE policy comprises access traffic steering, switching, splitting (ATSSS) rules and UE route selection policy. The software code 215 may be stored in the ROM 211b. The apparatus 200 may implement one or more NFs of the 5GC and may be interconnected with another apparatus 200 implementing one or more other NFs of the 5GC. In such embodiments, the apparatuses 200 may be part of a distributed computing system. In some embodiments, each NF of the 5GC may be implemented on a single apparatus 200. In such embodiments, the apparatus 200 may be a cloud computing system.

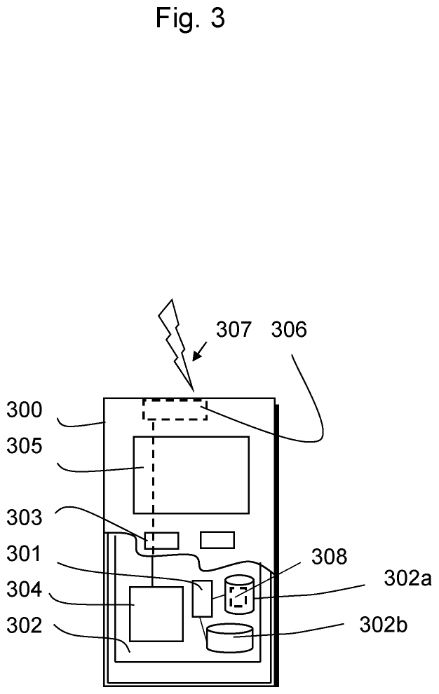

FIG. 3 illustrates an example of an apparatus 300 illustrated on FIG. 1. The apparatus 300 may be any wireless communication device capable of sending and receiving radio signals. Non-limiting examples of an apparatus 300 comprise a terminal, a wireless communication device, user equipment (UE), a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) communication device or any combinations of these or the like. In the following discussion the examples are generally concerned with a user equipment but it would be understood that the same principles can be applied to any of the examples of apparatus discussed above.

The apparatus 300 may be configured to communicate with base stations (e.g., a NG-eNB or a gNB) of an access network, such as the 5G-RAN and the 5GC via the base stations of the 5G-RAN using non-access stratum (NAS) signalling, for example, to communicate of data. Additionally in some embodiments the apparatus 300 may be configured to communicate with other access network nodes, for example satellites (in NEO, MEO or GEO) of a NT-AN.

The communications may include or carry one or more of voice, electronic mail (email), text message, multimedia, data, machine data and so on.

The apparatus 300 may receive wireless signals (e.g., radio or cellular signals) over an air or radio interface 307 (generally referred to as a Uu interface) via appropriate apparatus 306 for receiving the wireless signals and may transmit wireless signals e.g., radio or cellular signals) via appropriate apparatus for transmitting the wireless signals. In FIG. 3 the apparatus 306 includes one or more antennas (or an antenna array comprising a plurality of antennas) and a transceiver and is designated schematically by block 306. The apparatus 306 may be provided for example by means of a radio part and associated antenna arrangement comprising one or more antennas. The antenna arrangement may be arranged internally or externally to the mobile device.

The apparatus 300 may include at least one processor 301, at least one memory ROM 302a, at least one RAM 302b and other possible components 303 for use in software and hardware aided execution of tasks it is designed to perform, including control of access to and communications with access networks, such as the 5G-RAN access network or the NTN access network, and other apparatuses 300. The at least one processor 301 is coupled to the RAM 311a and the ROM 311b. The at least one processor 301 may be configured to execute an appropriate software code 308. The software code 308 may for example include instructions which when executed by the at least one processor 301 perform one or more actions or operations of present aspects. For example, the software code can comprise instructions suitable for implementing one or more actions or operations in accordance with aspects of the present disclosure. The software code 308 may be stored in the ROM 311b.

The at least one processor 301, storage and other relevant apparatus can be provided on an appropriate circuit board or chipsets, or circuit board and chipsets. This feature is denoted by reference 304. The terminal 300 may optionally have a user interface such as keypad 305, touch sensitive display screen or touch sensitive pad, combinations thereof or the like. Optionally one or more of a display, a speaker and a microphone may be provided depending on the type of the device.

The following examples explain procedures for establishment of a multi-access data session comprising multiple legs over multiple accesses of the same access type (e.g., multiple legs over multiple 3GPP access and/or multiple legs over multiple non-3GPP access) in one or multiple mobile networks. In the following examples, a policy control function (PCC) of the core network (e.g., 5GC) of the mobile network provides a UE policy to the terminal (e.g., UE) that includes UE policy information that is used by the terminal (e.g., UE) when the terminal (e.g., UE) requests establishment of a multi-access data session (e.g., a MA PDU session) comprising multiple legs over multiple 3GPP accesses and/or multiple non-3GPP accesses. Furthermore, the following examples describe how a terminal (e.g., UE) determines which accesses from those accesses that the UE is registered over to request establishment of a multi-access data session comprising multiple legs. Moreover, in the following examples, the terminal (e.g., UE) can determine whether there is a dependency between legs of the multi-access data session (in other words whether a multi-access data session comprising pairs or groups of legs over an access because of information indicating a dependency between the legs).

Additionally in the following examples, the terminal (e.g., the UE) may determine whether there is any conflict between the UE policy information that is used by the UE to determine which accesses to employ for requesting establishment of a multi-access data session (e.g., a MA PDU session) comprising multiple legs over multiple access and ATSSS rules provided by the PCF.

In some embodiments, a core network (5GC) of a mobile network is configured to provide a UE policy (to the UE) comprising UE policy information indicating preferences regarding which legs of multi-access data session to establish for specific application traffic. In some embodiments, the UE policy information includes information about each leg of the multi-access data session that should be established. In some embodiments, the UE policy information includes a description of each leg of the multi-access data session that that should be established.

This UE policy information can be employed (or used) by the terminal (e.g., UE) when the terminal (e.g., UE) requests establishment of a multi-access data session. When the (e.g., UE) requests establishment of a multi-access data session, the terminal (e.g., UE) requests establishment of a multi-access data session comprising only the legs indicated in the UE policy information. For example, the preferences regarding which legs (access paths) of multi-access data session to establish for specific application traffic may be represented using a 5-tuple, which address; source IP port number; destination IP port number and protocol). In this example, the UE requests establishment of a multi-access data session comprises establishing a leg over NR, a leg over LTE and a leg over non-3GPP access but not establishing a leg over NTN.

In some embodiments, the UE policy information comprises information about each respective leg of the multi-access data session that should be established. In some embodiments, the information about each respective leg of the multi-access data session that should be established comprises information indicative of an access type of the access on which the respective leg is established over, and a RAT of the access. In some embodiments, the UE policy information comprises an identifier of the mobile network (e.g., a Network ID) that the access is in. The Network ID may be a PLMN ID or a SNPN ID. Alternatively, or in addition, in some embodiments, the information about each leg of the multi-access data session that should be established also comprises an identifier of a registration (e.g., Registration ID) which identifies the registration corresponding to the access the leg is established over.

Thus, in some embodiments, the UE is configured to request establishment of a multi-access data session (e.g., a MA PDU session) comprising multiple legs (access paths) over multiple accesses of the same access type, where the multiple legs (access paths) correspond with the legs indicated in the UE policy information received from the core network of the mobile network, subject to the core network being capable of establishing the legs (access paths) (e.g. the access networks of the accesses that the legs are established on have coverage for the UE or the UE has corresponding access to the access networks).

In some embodiments, the UE can be configured to request establishment of a multi-PDU session comprising multiple legs over multiple access corresponding to the accesses indicated in the UE policy information and for which the UE has already registered over.

In some other embodiments, the UE policy information can also be employed (or used) by the terminal (e.g., UE) to determine whether to trigger, initiate or request a new registration with the core network of the mobile network over an access that is indicated in the UE policy information for which the terminal (e.g., UE) has not yet registered over.

This UE policy information can, in some embodiments, be provided to the UE in a user equipment route selection policy (URSP) rule.

However, the UE policy information can, in some embodiments, be provided to the UE using some other means, for example via control plane signalling or via user plane signalling. In some embodiments, the UE policy information could be provided via policies delivered by the PCF over the control plane (for example a NAS messages exchanged between UE and AMF). In some embodiments the UE policy information could be provided in policy other than a URSP.

In some embodiments user subscription information associated with the terminal (e.g., UE) includes information indicative of whether the terminal (e.g., UE), for a single-network slice selection assistance information (S-NSSAI) or a data network name (DNN), can request establishment of multi-access data session, such as multi-access session comprising multiple legs over multiple access of the same access type (e.g., over multiple 3GPP access or over multiple non-3GPP accesses). Furthermore, in some embodiments the user subscription information associated with the terminal (e.g., UE) includes information indicating the access types of the legs of the multi-access data session that may be established.

Thus, for example, the policy information can include information indicating whether the legs of the multi-access data session can be established over accesses in a mobile network (PLMN or SNPN) or two different mobile networks (two PLMNs, a PLMN and a SNPN or two SNPNSs).

Additionally in some embodiments the terminal (e.g., UE) may request a release of one leg of a multi-access data session. In these embodiments, the terminal (e.g., UE) may initiate a procedure to modify the multi-access data session to release a leg of a multi-access data session when detecting, based on measurements, that the terminal (e.g., UE) is no longer capable of communicating with the access network of an access over which the leg is established (e.g., the terminal (e.g., UE) is outside the coverage area of the access network of an access over which the leg is established).

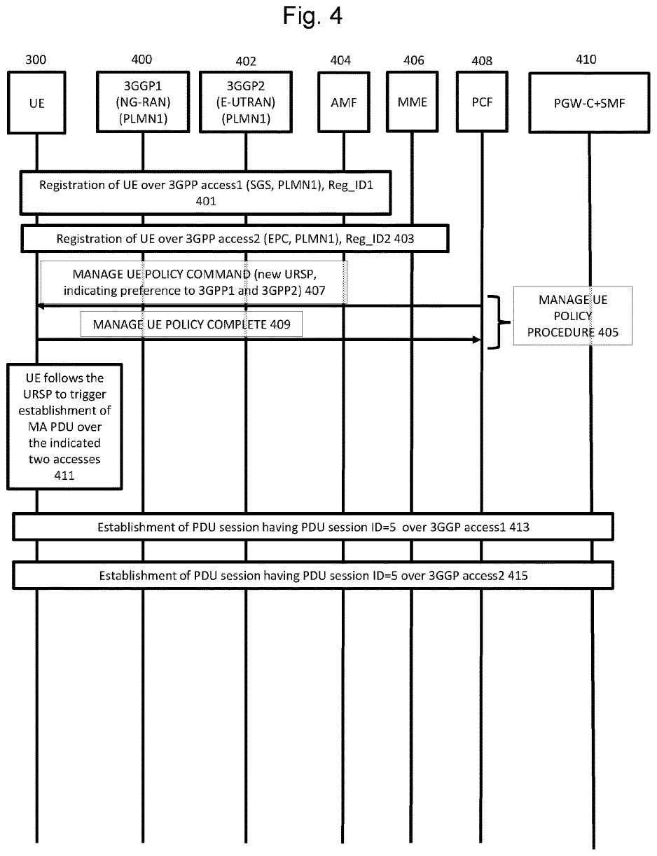

A first example of a flow diagram showing a procedure for establishment of a multi-data session comprising multiple legs over multiple access of the same access type in a mobile network is shown in FIG. 4. In this example the policy information is provided within a URSP sent to a terminal (shown as UE 300 in FIG. 4) by a PCF 408 of the mobile network (PLMN1). In other words, in this example, a UE 300 receives a URSP from the PCF 408 comprising the policy information. The policy information includes information indicating a preference with respect to which legs shall be established over which accesses for a multi-access data session (e.g., MA PDU session). In this example, UE 300 can establishment of a multi-access data session (e.g., a MA PDU session) comprising a first leg over a first access (3GGP access1) comprising a first access network (shown as 3GPP1 (NG-RAN)) 401) belonging to a mobile network (PLMN1), and a second leg over a second access (3GPP access2) comprising a second access network (shown as 3GPP2 (E-UTRAN) 402)) which also belongs to the mobile network (PLMN1). FIG. 4 also shows an AMF (Access and Mobility Management Function) 404, MME (Mobility Management Entity) 406, and PGW-C+SMF (packet data network gateway and session management function) 410 similar to those described with respect to FIG. 1 above.

In the example shown in FIG. 4 UE 300 registers with the AMF 404 over the first access (3GPP access1) and the MME 406 over the second access (3GPP access2) to establish dual NR or LTE registrations with the AMF 404 and the MME 406 of the mobile network (PLMN1).

This is shown at 401 in FIG. 4, by a ‘registration’ of the UE 300 with the AMF 404 over the first access (3GPP access 1) and at 403 by a ‘registration’ of the UE 300 with the MME 406 over the second access (3GPP access2). The ‘registration’ of the UE 300 with the AMF 404 over the first access (3GPP access1) at 401 is a procedure in which the UE 300 registers with the AMF 404 over the first access (3GPP access 1) via the first access network (3GPP1 (NG-RAN) 400) belonging to the mobile network (PLMN1). The procedure in which the UE 300 registers with the AMF 404 is described above with respect to the description of FIG. 1. In some embodiments, when the UE 300 requests registration with the AMF 404 over the first access (3GPP access1), the UE 300 may send a registration request to the AMF 404 that includes an identifier of the mobile network (PLMN1) that UE 300 is requesting registration with and/or an identifier indicating which registration (Reg_ID1) of the dual registrations is being requested.

The ‘registration’ of the UE 300 with the MME 406 over the second access (3GPP access2) at 403 is a procedure in which the UE 300 registers with the MME 406 over the second access (3GPP access2) via the second access network (3GPP2 (E-UTRAN) 402) belonging to the mobile network (PLMN1). In some embodiments, when the UE 300 requests registration with the MME 406 over the second access (3GPP access2), the UE 300 may send a registration request to the MME 406 that includes an identifier of the mobile network (PLMN1) that UE 300 is requesting registration with and/or an identifier indicating which registration (Reg_ID2) of the dual registrations is being requested.

In this example, the PCF 408 can then perform a manage a UE policy procedure, as shown by 405. The manage the UE policy procedure performed by the PCF 408 can, for example, comprise, as shown at 407, the PCF 408 sending a manage UE policy command message to the UE 300. The UE policy command sent by the UE 300, in this example, comprises the URSP which includes the policy information with respect to a preference to establish legs of a multi-access data session over the first access (3GPP access1) and the second access (3GPP access2).

The UE 300 can acknowledge the receipt of the UE policy command message at 409 where the UE sends a manage UE policy complete message to the PCF 408.

Thus, the PCF 408 in this example is configured to send the URSP comprising the policy information indicating a preference to establish legs for a multi-access data session (e.g., MA PDU session) over the first and second accesses (3GPP access1 and 3GPP access2). In other words, the policy information indicates a preference to establish a multiple-access data session (e.g., MA PDU session) comprising a first leg over the first access (3GPP access1) and a second leg over the second access (3GPP access2). In some embodiments, the policy information may be a URSP rule (or URSP rules).

Furthermore, the UE 300 is configured as shown, at 411, to follow the policy information included in the URSP (e.g., the URSP rules). For example, the UE 300 is configured to use the policy information included in the URSP to select accesses from which to send requests to establish legs for a multi-access data session (e.g., MA PDU session).

The UE 300 is configured to request establishment of a multi-access data session (e.g., the same MA PDU session) comprising a first leg over the first access (3GPP access1) and a second leg over the second access (3GPP access) based on the policy information included in the received URSP. This is shown by 413 where a procedure to request establishment of a first leg of a muti-access data session (e.g., PDU session having a PDU session ID=5) over the first access (3GPP1 access1) and by 415 where the UE 300 requests establishment of muti-access data session (e.g., PDU session having a PDU session ID=5) over the second access (3GPP2 access2).

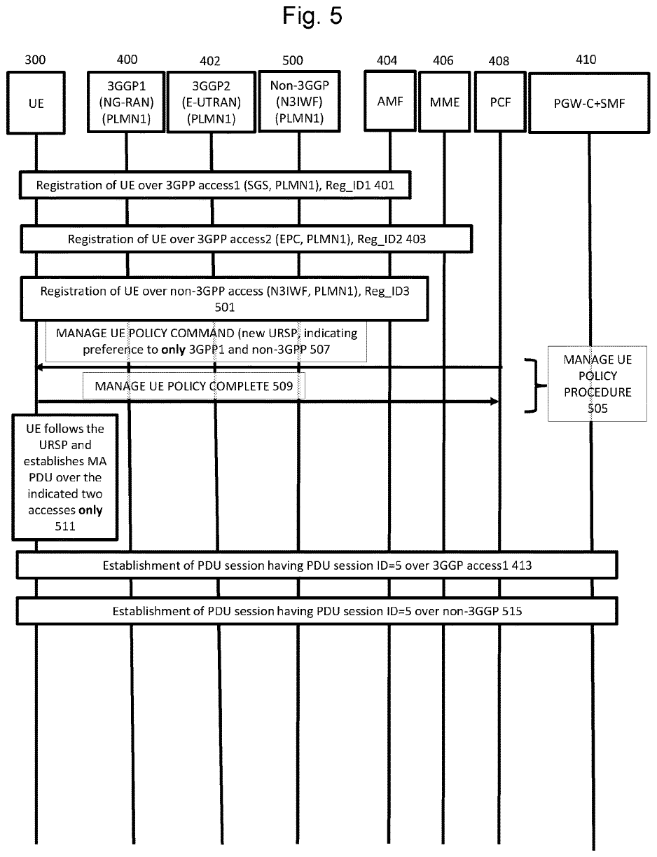

A second example of a flow diagram showing a procedure for establishment of a multi-data session comprising multiple legs over multiple access of the same access type in a mobile network is shown in FIG. 5. In this example the policy information is provided within a URSP sent to a terminal (shown as UE 300 in FIG. 5) by a PCF 408 of the mobile network (PLMN1). In other words, in this example, a UE receives a URSP from the PCF 408 comprising the policy information. The policy information includes information indicating a preference with respect to which legs shall be established over which accesses for a multi-access data session (e.g., MA PDU session). In this example, UE 300 can establishment of a multi-access data session (e.g., a MA PDU session) comprising a first leg over a first access (3GGP access1) comprising a first access network (shown as 3GPP1 (NG-RAN)) 401) belonging to a mobile network (PLMN1), a second leg over a second access (3GPP access2) comprising a second access network (shown as 3GPP2 (E-UTRAN) 402)) which also belongs to the mobile network (PLMN1), and a third leg over a third access (non-3GGP access) comprising an N3IWF and a third access network (shown as non-3GPP (I3IWF) 500). FIG. 5 also shows an AMF (Access and Mobility Management Function) 404, MME (Mobility Management Entity) 406, PCF (Policy Control Function) 408 and PGW-C+SMF (packet data network gateway and session management function) 410 similar to those described with respect to FIG. 1 above.

In the example shown in FIG. 5 UE 300 registers with the AMF 404 over the first access (3GPP access1), the MME 406 over the second access (3GPP access2), and the AMF 404 over the third access (non-3GPP access) to establish multiple registrations with the mobile network (PLMN1).

This is shown at 401 in FIG. 5, by a ‘registration’ of the UE 300 with the AMF 404 over the first access (3GPP access 1), at 403 by a ‘registration’ of the UE 300 with the MME 406 over the second access (3GPP access2), and at 501 by ‘registration’ of the UE 300 with the AMF 404 over the third access (non-3GPP). The ‘registration’ of the UE 300 with the AMF 404 over the first access (3GPP access1) at 401 is a procedure in which the UE 300 registers with the AMF 404 over the first access (3GPP access 1) via the first access network (3GPP1 (NG-RAN) 400) belonging to the mobile network (PLMN1). The procedure in which the UE registers with the AMF 404 is described above with respect to the description of FIG. 1. In some embodiments, when the UE 300 requests registration with the AMF 404 over the first access (3GPP access1), the UE 300 may send a registration request to the AMF 404 that includes an identifier of the mobile network (PLMN1) that UE 300 is requesting registration with and/or an identifier indicating which registration (Reg_ID1) of the multiple registrations is being requested.

The ‘registration’ of the UE 300 with the MME 406 over the second access (3GPP access2) at 403 is a procedure in which the UE 300 registers with the MME 406 over the second access (3GPP access2) via the second access network (3GPP2 (E-UTRAN) 402) belonging to the mobile network (PLMN1). In some embodiments, when the UE 300 requests registration with the MME 406 over the second access (3GPP access2), the UE 300 may send a registration request to the MME 406 that includes an identifier of the mobile network (PLMN1) that UE 300 is requesting registration with and/or an identifier indicating which registration (Reg_ID2) of the multiple registrations is being requested.

The ‘registration’ of the UE 300 with the AMF 404 over the third access (non-3GPP access) at 501 is a procedure in which the UE 300 registers with the AMF 404 over the third access (non-3GP) via the N3IWF and the third access network (non-3GPP (N3IWF) 500) belonging to the mobile network (PLMN1). In some embodiments, when the UE 300 requests registration with the AMF 404 6 over the third access (non-3GPP access), the UE 300 may send a registration request to the AMF 404 that includes an identifier of the mobile network (PLMN1) that UE 300 is requesting registration with and/or an identifier indicating which registration (Reg_ID3) of the multiple registrations is being requested.

As shown in FIG. 5, the PCF 408 may perform a UE policy management procedure 505 similar to the UE policy management procedure 405. The UE policy management procedure 505 can comprise, as shown at 507, the PCF 408 sending a UE policy command message to the UE 300. The UE policy command message in this example comprises a URSP which includes policy information indicating a preference for the establishment of a multi-access data session (e.g., MA PDU session) comprising only legs over the first accesses (3GPP access1) and over the third access (non-3GPP access). In other words, the URSP comprises policy information indicating a bar or restriction to requesting establishment of a leg of the multi-access data session (e.g., MA PDU session) over the second access (3GPP access2) or a preference not to request establishment of a leg of the multi-access data session over the second access (3GPP access2).

The UE 300 can acknowledge receipt of the UE policy command at 509 where the UE 300 sends a manage UE policy complete message to the PCF 408.

Thus, the PCF 408 in this example is configured to send a new URSP comprising policy information (i.e., multi-access preference information) indicating preferences for the UE to request establishment of a multi-access data session (e.g., MA PDU session) comprising legs over only the first access (3GPP access1) and the third access (non-3GPP access).

The UE 300 as shown at 511 is configured to follow the received URSP (i.e., follow the policy information included in the received URSP. For example, the UE 300 is configured to use the policy information included in the URSP to select accesses from which to send requests to establish legs for a multi-access data session (e.g., MA PDU session).

The UE 300 is configured to request establishment of a multi-access data session (e.g., the same MA PDU session) comprising a first leg over the first access (3GPP access1) and a second leg over the third access (non-3GPP access) based on the policy information included in the received URSP. This is shown by 413 where the UE requests an establishment of a first leg of a multi-access data session (e.g., PDU session having a PDU session ID=5) over access path 3GPP1 and by 515 where the UE requests an establishment of a second leg over access path non-3GPP for the same multi-access data session (e.g., the PDU session having the PDU session the PDU session ID=5).

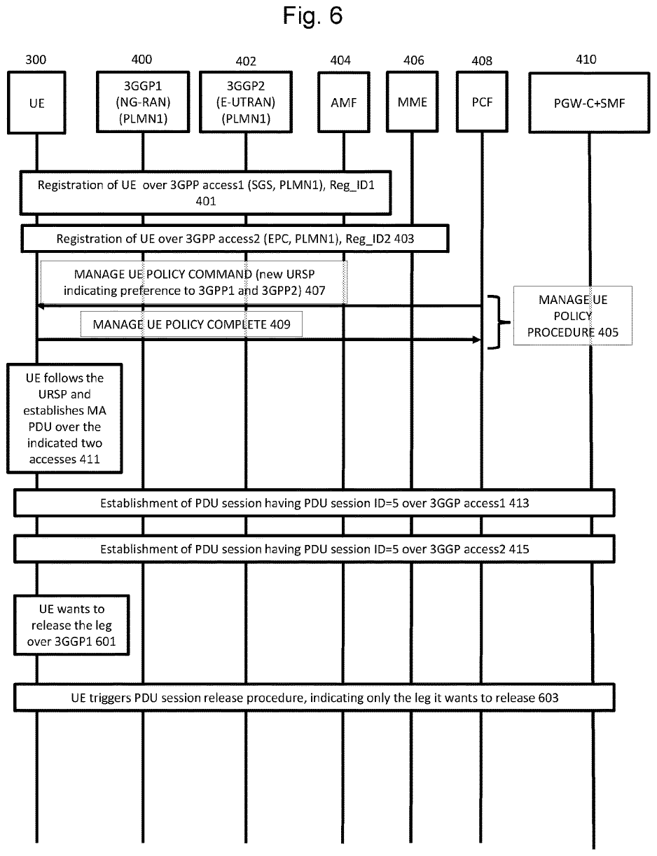

A third example of a flow diagram showing a procedure for establishment of a multi-data session comprising multiple legs over multiple access of the same access type in a mobile network is shown in FIG. 6. In the flow diagram shown FIG. 6, the operations or actions 401, 403, 405, 407, 409, and 411 are the same operations which were described with respect to the flow diagram of FIG. 4 and hence are not detailed any further.

In the flow diagram shown in FIG. 5, after the multi-access data session (having the PDU session ID=5) is established (i.e., the multi-access data session comprising a first leg over a first access (3GPP access1) and a second leg over a first access (3GPP access1) is established), the UE 300 determines to release one leg of the two legs of the multi-access data session (e.g., MA PDU session) based on a suitable trigger event. In this example, the UE determines to release the leg over the first access (3GPP access 1) based on a suitable trigger event. In some embodiments, the trigger event may include the UE 300 detecting based on measurements of signal strength the access network (3GPP1 (NG-RAN 400)) of the first access (3GPP access1) that the UE 300 is close to losing coverage from the access network (3GPP1 (NG-RAN 400)) of the first access (3GPP access1) or has lost coverage from the access network (3GPP1 (NG-RAN 400)) of the first access (3GPP access1).

In some examples, the trigger event can be coverage related, for example a NTN or satellite network of the access network (3GPP1 NG-RAN 400) of the first access (3GPP access1) where the LEO or MEO satellite constellation of the NTN or satellite network is unable to provide a suitable number or distribution of satellites within reach of the UE antenna beam and thus the UE 300 may determine that coverage from the NTN or satellite network is lost or degraded below an acceptable bandwidth or reliability measurement and determine to release the leg of the multi-access data session over the first access (3GPP access1). In some examples, a trigger event can be related to capacity where the UE 300 determines that one of the legs over an access (which is overloaded) has become unable to maintain a sufficient bit rate or maintain an error rate below a defined threshold error rate. In this example, the UE 300 determines to request a release of the leg over the access which is overloaded (e.g., release the leg of the multi-access data session over 3GGP access1).

After the UE 300 to release one leg of the two legs of the multi-access data session (e.g., MA PDU session), the UE 300 triggers or initiates a procedure to release the one leg from the multi-access data session. In the example shown in FIG. 6, the UE 300 may UE 300 trigger or initiate PDU Session Release procedure and request that the PGW-C+SMF 410 release the leg over the first access (3GGP access1) from the multi-access data session (e.g., MA PDU session). This is shown in FIG. 6, by 601, where the UE 300 determines to release the leg of the multi-access data session (e.g., MA PDU session) over the first 3GPP access (3GGP1), and triggers or initiates a procedure to modify the multi-access data session (e.g., the MA PDU session) by sending a PDU session release message to the PGW-C+SMF 410. The PDU session release message may include an indication of the leg of the multi-access data session the UE 300 is requesting the PGW-C+SMF 410 to release from the multi-access data session, as shown by 603.

In the examples described above with respect to FIGS. 4, 5, and 6, the UE 300 registered with an AMF 404 and a MME 406 over different accesses (3GPP access1, 3GPP access2, and non-3GPP access) which all belong to the same mobile network (PLMN) and requested establishment of legs of a multi-access data session (e.g., MA PDU session) over the multiple accesses. It will be appreciated that in some embodiments, the AMF 404 and the MME 406 may belong to different mobile networks (e.g., PLMN 1 and PLMN2) and the UE 300 may register with an AMF 404 and a MME 406 over different accesses (3GPP access1, 3GPP access2, and non-3GPP access) and establish legs over multiple different accesses3GPP access1, 3GPP access2, and non-3GPP access) that belong to the different mobile networks as described above.

The policy information included in URSP may be a URSP rule as described above. A URSP rule can be as shown in 3GPP TS 24.526, Table 5.2.1. In an example embodiment, UE policy includes a URSP rule and the URSP rules comprises a route selection descriptor component type identifier includes the element marked below in bold and designated ‘multi-leg preference type’ which can comprise the preference information for assisting the UE 300 in the selection of suitable accesses and the requesting of establishment of legs of the multi-access data session over the selected accesses.

Route selection descriptor component type identifier

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | SSC mode type |
| 0 | 0 | 0 | 0 | 0 | 0 | 1 | 0 | S-NSSAI type |
| 0 | 0 | 0 | 0 | 0 | 1 | 0 | 0 | DNN type |
| 0 | 0 | 0 | 0 | 1 | 0 | 0 | 0 | PDU session type type |
| 0 | 0 | 0 | 1 | 0 | 0 | 0 | 0 | Preferred access type type |
| 0 | 0 | 0 | 1 | 0 | 0 | 0 | 1 | Multi-access preference type |
| 0 | 0 | 0 | 1 | 0 | 0 | 1 | 1 | Multi-leg preference type |
| 0 | 0 | 1 | 0 | 0 | 0 | 0 | 0 | Non-seamless non-3GPP offload |
| | | | | | | | | indication type |
| 0 | 1 | 0 | 0 | 0 | 0 | 0 | 0 | Location criteria type |
| 1 | 0 | 0 | 0 | 0 | 0 | 0 | 0 | Time window type |
| 1 | 0 | 0 | 0 | 0 | 0 | 0 | 1 | 5G Prose layer-3 UE-to-network |
| | | | | | | | | relay offload indication type |
| 1 | 0 | 0 | 0 | 0 | 0 | 1 | 0 | PDU session pair ID type |
| 1 | 0 | 0 | 0 | 0 | 0 | 1 | 1 | RSN type |

All other values are spare. If received they shall be interpreted as unknown.

For “multi-leg preference type”, the route selection descriptor component value field can be encoded as one octet indicating a number of multi-leg preference fields followed by the octets of the multi-leg preference fields.

The octets of the multi-leg preference field contain information identifying the access type and information identifying a RAT. In some embodiments the octets comprise a registration ID that corresponds to the registration identifier included in the respective registration requests sent by the UE 300 when the UE 300 registers with the AMF 404 and the MME 406 over different accesses and which corresponds to a preferred or barred accesses. In some embodiments, the octets of the multi-leg preference field contain information indicating identifies whether legs of the multi-access data session are preferred to be established over accesses belonging to (or in) one mobile network (or in different mobile networks. In some embodiments, the octets of the multi-leg preference field contain information that indicates a negative preference or a bar for establishing a leg over a particular access.

For example:
Octet 1 (multi-leg preference field 1) contains access type/RAT type
Octet 2 (multi-leg preference field 2) contains access type/RAT type
Octet 3 (multi-leg preference field 3) contains access type/RAT type
. . .
OR:
Octet 1 (multi-leg preference field 1) contains registration ID 1
Octet 2 (multi-leg preference field 2) contains registration ID 2
Octet 3 (multi-leg preference field 3) contains registration ID 3
. . .

In some embodiments each octet indicates the identifier of the mobile network, such as PLMN ID or SNPN ID, which identifies whether legs of the multi-access session are over accesses in same mobile network or different mobile networks.

In some embodiments if the PCF includes a “multi-leg preference type” in a route selection descriptor, the PCF is not expected to include “preferred access type” type nor the “multi-access preference type” in that route selection descriptor.

Furthermore in some embodiments where the information comprises both “multi-leg preference type” values identifying an access and “preferred access type” values identifying a single preferred access or “multi-access preference type” value identifying multiple accesses preferences within the route selection descriptor then a UE is configured to select accesses and request establishment of legs for a multi-access data session over the selected access based on the “multi-leg preference type” values and ignore the “preferred access type” type value or “multi-access preference type” value from the route selection descriptor. Furthermore if there are both “multi-leg preference type” values and “preferred access type” values or “multi-access preference type” values within the route selection descriptor components in a single route selection descriptor then a UE can be configured to only considering the “preferred access type” value or “multi-access preference type” value route selection descriptor where the UE does not support the requesting of establishment of multi-access data sessions in a manner as described herein.

The preferred access type and preferred multi-access type information is further defined in TS 24.526 and indicates respectively access types and access types for multi-access data sessions (i.e., data sessions over multiple access). For example, the preferred access type indicates the preferred Access Type (3GPP access or non-3GPP access) when a UE establishes a PDU Session for the matching application and multi-access type information indicates that the PDU session should be established as a multi-access PDU session, using both 3GPP access and non-3GPP access.

It should be understood that a base station described herein may comprise units or module, such as radio parts or radio heads, used in or for transmission, reception or transmission and reception. Although a base station have been described as one entity, different modules and memory may be implemented in one or more physical or logical entities.

It is noted that whilst some embodiments have been described in relation to 5G systems, similar principles can be applied in relation to other networks and communication systems. Therefore, although certain embodiments were described above by way of example with reference to certain example architectures for radio access and core networks, radio access technologies and standards, embodiments may be applied to any other suitable forms of communication systems that implement other radio access technologies than those illustrated and described herein.

It is also noted herein that while the above describes example embodiments, there are several variations and modifications which may be made to the disclosed solution without departing from the scope of the present invention.

In general, the various embodiments, the functions and operations described above may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based-memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuits. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog or digital or hybrid analog and digital hardware circuit(s) with software or firmware or software and firmware and
(ii) any portions of hardware processor(s) with software (including digital signal processor(s)), software, and memory (ies) that work together to cause an apparatus, such as a mobile phone or server, to perform various functions) and hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of the term “means” and/or “circuitry” in this application, including in any claims. As a further example, as used in this application, the term circuitry also covers an implementation of merely a hardware circuit or processor (or multiple processors) or portion of a hardware circuit or processor and its (or their) accompanying software or firmware or software and firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising:
at least one processor; and
at least one memory storing instructions which, when executed by the at least one processor, cause the apparatus to perform operations, the operations comprising:
receiving a policy from a core network of a mobile network, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard;
selecting, for the multi-access data session, at least two access paths from the plurality of access paths based on the policy information; and
requesting establishment of the multi-access data session comprising the selected at least two access paths, the selected at least two access paths being over the at least two accesses operating according to the first standard or at least two accesses operating according to the further standard.

2. The apparatus as claimed in claim 1, wherein the at least two accesses operating according to a first standard are 3GPP accesses and the at least two accesses operating according to a further standard are non-3GPP accesses.

3. The apparatus as claimed in claim 1, wherein the policy information indicating preferences regarding which accesses paths from a plurality of access paths are to be established for a multi-access data session for application traffic comprises, for each access path, at least one of:
a description of the application traffic for the multi-access data session;
an identifier identifying an access over which the apparatus is registered with the mobile network;
an identifier identifying a type of an access of the access path;
an identifier identifying a radio access technology of the access;
a combination of a source IP address, a destination IP address, a source port number, a destination port number, and a protocol of the multiple access data session;
an identifier identifying a mobile network the access path is in; and
an identifier identifying a network operator of a mobile network the access path is in.

4. The apparatus as claimed in claim 1, wherein the selecting, for the multi-access data session, at least two access paths from the plurality of access paths based on the policy information comprises selecting the at least two access paths from the plurality of access paths that:
correspond to access paths identified within the policy information; and
via accesses which the apparatus is registered with the mobile network.

5. The apparatus as claimed in claim 1, wherein the selecting, for the multi-access data session, at least two access paths from the plurality of access paths based on the policy information comprises selecting at least two access from a plurality of accesses that correspond to access paths identified within the policy information.

6. The apparatus as claimed in claim 5, wherein the requesting the establishment of the multi-access data session comprising the selected at least two access paths further comprises:
requesting registration with the mobile network over at least one of the accesses on which the selected at least two access paths are to be established; and
requesting establishment of the selected at least two access paths.

7. The apparatus as claimed in claim 1, wherein the policy comprises a user equipment route selection policy, and the policy information is a route selection descriptor component type identifier comprising the preferences on which access paths from the plurality of access paths the multi-access data session for the application traffic is to be established.

8. The apparatus as claimed in claim 1, wherein the policy information comprises user subscription information indicating a multi-access data session can be requested to be established by the apparatus over at least one of: a defined type of access; and a defined radio access technology, wherein the multi-access data session is for at least one of: a defined single-network slice selection assistance information; and a defined data network name.

9. The apparatus as claimed in claim 1, wherein the operations further comprise:
requesting, for the multi-access data session, a release of at least one of the selected at least two access paths.

10. The apparatus as claimed in claim 9, wherein the requesting for the multi-access data session, the release of at least one of the selected at least two access paths comprises requesting the release of the at least one of the selected at least two access paths based on a determination of a substantial loss of connectivity to an access network in one of the selected at least two access paths.

11. An apparatus for a mobile network, the apparatus comprising:
at least one processor; and
at least one memory storing instructions which, when executed by the at least one processor, cause the apparatus to perform operations, the operations comprising:
generating a policy, the policy comprising policy information indicating preferences regarding which accesses paths from a plurality of access paths are to be established for a multi-access data session for application traffic, the plurality of access paths being over at least two access operating according to a first standard or at least two access operating according to a further standard; and
sending the policy to a further apparatus registered with the mobile network.

12. The apparatus as claimed in claim 11, wherein the at least two accesses operating according to a first standard are 3GPP accesses and the at least two accesses operating according to a further standard are non-3GPP accesses.

13. The apparatus as claimed in claim 11, wherein the information indicating preferences regarding which accesses paths from a plurality of access paths are to be established for a multi-access data session for application traffic comprises, for each access path, at least one of:
a description of the application traffic for the multi-access data session;
an identifier identifying an access over which the further apparatus is registered with the core network;
an identifier identifying a type of an access;
an identifier identifying a radio access technology of an access;
a combination of a source IP address, a destination IP address, a source port number, a destination port number, and a protocol of the multiple access data session;
an identifier identifying a mobile network the access path is in; and
an identifier identifying a network operator of a mobile network the access path is in.

14. The apparatus as claimed in claim 11, wherein the policy comprises a user equipment route selection policy, the policy information is a route selection descriptor component type identifier comprising the preferences on which access paths from the plurality of access paths the multi-access data session is to be established.

15. The apparatus as claimed in claim 1, wherein the policy information comprises user subscription information indicating that a multi-access data session can be requested to be established by the further apparatus over at least one of: a defined type of access; and a defined radio access technology, wherein the multi-access data session is for at least one of: a defined single-network slice selection assistance information; and a defined data network name.

16-19. (canceled)

20. A method comprising:
receiving a policy from a core network of a mobile network, the policy comprising policy information indicating preferences regarding which accesses paths from a plurality of access paths are to be established for a multi-access data session for application traffic, the plurality of access paths being over at least two accesses operating according to a first standard or at least two accesses operating according to a further standard;
selecting, for the multi-access data session, at least two access paths from the plurality of access paths based on the policy information; and
requesting establishment of the multi-access data session comprising the selected at least two access paths, the selected at least two access paths being over the at least two accesses operating according to the first standard or at least two accesses operating according to the further standard.

21. The method as claimed in claim 21, wherein the at least two accesses operating according to a first standard are 3GPP accesses and the at least two accesses operating according to a further standard are non-3GPP accesses.

22. The method as claimed in claim 21, wherein the policy information indicating preferences regarding which accesses paths from a plurality of access paths are to be established for a multi-access data session for application traffic comprises, for each access path, at least one of:
a description of the application traffic for the multi-access data session;
an identifier identifying an access over which the apparatus is registered with the mobile network;
an identifier identifying a type of an access of the access path;
an identifier identifying a radio access technology of the access;
a combination of a source IP address, a destination IP address, a source port number, a destination port number, and a protocol of the multiple access data session;
an identifier identifying a mobile network the access path is in; and
an identifier identifying a network operator of a mobile network the access path is in.

23. The method as claimed in claim 21, wherein the selecting, for the multi-access data session, at least two access paths from the plurality of access paths based on the policy information comprises selecting the at least two access paths from the plurality of access paths that:
correspond to access paths identified within the policy information; and
via accesses which the apparatus is registered with the mobile network.

24. The method as claimed in claim 21, wherein the selecting, for the multi-access data session, at least two access paths from the plurality of access paths based on the policy information comprises selecting at least two access from a plurality of accesses that correspond to access paths identified within the policy information.
